(19) United States
(12) Patent Application Publication
(10) Pub. No.: US 2013/0323754 A1
(43) Pub. Date: Dec. 5, 2013

(54) Diagnostic Kit as Well as a Metho dfor the Examination of a Human Patient Sample for the Presence of Neuromyelitis Optica-Specific Antibodies

(71) Applicant: Winfried Stocker, Gross Grönau (DE)

(72) Inventor: Winfried Stocker, Gross Grönau (DE)

(73) Assignee: Euroimum Medizinische Labordiagnostika, Lubeck (DE)

(21) Appl. No.: 13/985,719

(22) PCT Filed: Feb. 15, 2012
(86) PCT No.: PCT/DE2012/000133

§ 371 Date: Aug. 15, 2013

(30) Foreign Application Priority Data
Feb. 15, 2011 (DE) 10 2011 011 280.4

(51) Int. Cl. G01N 21/64

(52) U.S. Cl. CPC G01N 21/6486
USPC 435/7.21; 435/29

(57) ABSTRACT

A diagnostic kit as well as a method for the examination of a human patient sample for the presence of neuromyelitis optica-specific antibodies are described, for which an initial substrate is incubated with human sample material, and said incubated initial substrate is examined using indirect immunofluorescence, whether neuromyelitis optica-specific antibodies have at least partially bound to said initial substrate.

The solution described is characterized in that as said initial substrate, an aquaporin-4-containing native substrate is used as well as that said neuromyelitis optica-specific antibodies at least partially bound to said aquaporin-4-containing initial substrate are reacted with components of the complement system and the reaction of said complement system is detected by way of an indicator reaction.

Neuromyelitis optica (NMO-also Devic's syndrome) is an inflammatory autoimmune disease of the central nervous system. It particularly affects the spinal cord (myelitis) and the optic nerves (optic neuritis). The disease manifests itself with paralyses of arms and legs, loss of sensation and continence disorders; besides that, there is blindness of one or both eyes. Histologically, perivascular deposits of immunoglobulins and complement factors are found in the affected tissue.

For a long time, neuromyelitis optica was considered a variant of multiple sclerosis. However, it is an independent disease pattern, since certain autoantibodies occur in serum and liquor of most NMO patients, which are not present with multiple sclerosis. This is known from the publications “Weinshenker B G, Wingerchuk D M, Scottsdale Ariz., Lucchinetti C F, Lennon V A (2003): A marker autoantibody discriminates neuromyelitis optica from multiple sclerosis. Speakers abstracts about multiple sclerosis, 55^{th} annual meeting of the American academy of neurology, Mar. 29-Apr. 5, 2003”, “Lennon V A, Kryuzer T J (Nov. 25, 2003): Marker for neuromyelitis optica”, “Lennon V A, Wingerchuk D M, Kryzer T J, Pittock S J, Lucchinetti C F, Fujihara K, Nakashima I, Weinshenker B G (2004): A serum autoantibody marker of neuromyelitis optica: Distinction from multiple sclerosis. Lancet, 2106-12”, and US 2010/0112116 A1.

From “Lennon V A, Kryzer T J, Pittock S J, Verkman A S, Hinson S R (2005): IgG marker of optic-spinal multiple sclerosis binds to the aquaporin-4 water channel. J. Exp. Med. 202 (4): 473-7” it is known that the autoantibodies are directed against aquaporin-4, a component of the astrocytic cell membrane involved in the transmembrane water transport.

The target antigen is disclosed by EP 1 700 120 B1, wherein a method for the diagnosis of neuromyelitis optica by determination of the autoantibodies against aquaporin-4 in the serum is described.

A common test method for autoantibody determination is indirect immunofluorescence: in order to identify most different autoantibodies, autoantigen-containing tissue sections or cells are contacted with diluted patient serum (first incubation step). In that, with positive samples, the antibodies to be detected bind to the autoantigens. In a subsequent second step, the substrates are incubated with fluorescein-marked anti-human immunoglobulin antibodies, which then, in case of a positive result, can be identified under the fluorescence microscope. The fluorescence image corresponds to the distribution of the target antigens in the respective substrate.

Furthermore, there is the possibility, which is only rarely used in diagnostics, to determine, whether the autoantibodies bound to their target antigen in the indirect immunofluorescence test are able to activate the complement system. For that, following the first incubation step (sample), incubation takes place with a mixture of several normal serums (standardized complement source), and then with a fluorescein-marked anti-complement serum (for example anti-C1q, -C3c or -C4c). For chronic enteritis, Crohn's disease, for example, autoantibodies against pancreatic secretion are frequently found in the serum. A positive complement reaction of these antibodies is highly significantly correlated with the disease activity, which is known from “Stöcker W, Otte M, Ulrich S, Normann D, Stöcker K, Jantschek G. Autoantikörper gegen exokrines Pankreas und gegen intestinale Becherzellen in der Diagnostik des Morbus Crohn und der Colitis ulcerosa (1984). Dtsch Med Wschr 109(51-52): 1963-1969”.

In NMO lesions, activated complement could be detected at deposits of immune complexes. Furthermore, it is known from US 2010/0092478 A1 that, following binding with the antigen, autoantibodies against aquaporin-4 can activate complement and result in lysis of the target cell. The capacity of the autoantibodies against aquaporin-4 to bind complement was furthermore described by “Hinson S R, Pittock S J, Lucchinetti C F, Roemer S F, Fryer J P, Kryzer T J, Lennon V A. Neurology. 2007 Dec. 11; 69(24):2221-31. Epub 2007 Oct 10”. The subsequent publication “Waters, P. et al.: Aquaporin-4 Antibodies in Neuromyelitis Optica and Longitudinally Extensive Transverse Myelitis. In: Arch Neurol. Vol. 65, 2008, No. 7, p. 913-919” discloses the complement binding capacity (C3b) with 9/10 AQP4-Ab-positive NMO serums using AQP4-expressing recombinant cells.

The determination of the autoantibodies against aquaporin-4 has meanwhile been established in NMO diagnostics. So far, the most reliable results were provided by indirect immunofluorescence using transfected, aquaporin-4-derived protein-expressing mammal culture cells as antigen substrate. Here, the antigen is authentically presented to the autoantibodies, since it is still integrated in its natural environment. Compared to that, the use of Enzyme-Linked Immunosorbent Assays (ELISA) or radioimmunoassays (RIA) on the basis of antigen extracts is frequently problematic, since the tests are less sensitive and specific.

If no transfected cells, but frozen sections of neurological tissues, like hippocampus or cerebellum of various species, are used for indirect immunofluorescence, as is particularly known from “Weinshenker B G, Wingerchuk D M, Scottsdale Ariz., Lucchinetti C F, Lennon V A (2003): A marker autoantibody discriminates neuromyelitis optica from multiple sclerosis. Speakers abstracts about multiple sclerosis, 55^{th} annual meeting of the American academy of neurology, Mar. 29-Apr. 05, 2003”, antibodies against aquaporin-4 are only very difficult to identify. Thus, detection sensitivity highly decreases, because the intensity of the reaction mostly is not sufficient for clear positive signals. Furthermore, some further autoantibodies directed against neurological structures cannot be clearly distinguished, since immunohistochemically they present themselves with similar patterns.

The method according to the invention is characterized in that for the examination of the autoantibodies against aquaporin-4, first an aquaporin-4-containing native substrate is wetted with the preferably diluted sample, the bound antibodies are subsequently reacted with components of the complement system, and these are then finally represented by an indicator reaction. Here, in a preferred manner, a tissue section is first incubated with a patient serum. Subsequently, incubation is undertaken with a mixture of several normal serums as a standardized complement source as well as with a fluorescein-marked anti-complement serum, in particular with anti-C1q, -C3c or -C4c.

The example of the indirect immunofluorescence test has shown that with the complement variant, the reactions are much stronger than with a conventional test execution, in which the tissue section is incubated with the patient serum and subsequently with fluorescein-marked antihuman IgG. In a preferred manner, using the evaluation of a complement reaction according to the invention, the reaction pattern of the antiaquaporin-4 antibodies can be very well represented on the substrates hippocampus, optic nerve (nervus opticus) as well as cerebellum, without having to pre-treat the tissue and/or the patient serum for that. For this reason, the execution of such a test method can be performed substantially more effective, in particular with simpler means, than the tests known.

A further substantial advantage in the execution according to the invention of an examination for the presence of NMO-specific autoantibodies in a patient sample, in particular for the presence of aquaporin-4 autoantibodies, consists in the fact that with the detection of a complement activation based on the binding of autoantibodies to the target antigen, a secure differentiation from other autoantibodies is possible. In particular, it is reliably ensured that a patient serum may have autoantibodies against aquaporin-4, but has no other neurologically relevant autoantibodies, like, e.g., anti-NMDA receptors, anti-AMPA receptors, anti-glutamate decarboxylase, anti-CV-2, anti-LGI-1, anti-CASPR-2. This is based on the fact that, in a conventional test, anti-NMDA receptors, anti-AMPA receptors, anti-glutamate decarboxylase, anti-CV-2, Anti-LGI-1, Anti-CASPR-2 generate a similar fluorescence image on the tissue sections like autoantibodies against aquaporin-4, while the respective fluorescence images following incubation of the tissue section with a mixture of several normal serums and a fluorescein-marked anti-complement serum clearly differ. Also compared to other autoantibodies, like, for example, anti-myelin antibodies, anti-neuro-endothelium antibodies, anti-Hu antibodies or anti-Yo antibodies, which in a conventional test execution generated a similar fluorescence image like anti-aquaporin-4 on the tissue sections, the antiaquaporin-4 antibodies could be instantly identified via the representation by the complement.

Furthermore, the incubation of the tissue section with a mixture of several normal serums and a fluorescein-marked anti-complement serum with the objective of detecting complement activation is characterized by the fact that not only part of the anti-aquaporin-4 antibodies is recorded, as would be expected due to the example of the Crohn's diseaseassociated antibodies against pancreatic antigens stated above. Rather almost all anti-aquaporin-4 autoantibodies seem to bind complement, so that the complement variant appears to be at least partially superior to the immunofluorescence test on the basis of aquaporin-4-expressing cells in respect of sensitivity. Thus, tests have shown that the prevalences with NMO upon using immunofluorescence tests with tissue sections, which have AQP4-transfected cells, or ELISA or RIA, respectively, lie between 75 and 60%, while upon using the method according to the invention, prevalences of almost 100% are achievable.

One advantage of the method according to the invention for the diagnosis of neuromyelitis optica consists in the fact that contrary to known aquaporin-4 ELISA and RIA as well as to the common indirect immunofluorescence with transfected cells as the substrate, no recombinant antigens are required, but a test can be performed using native neurological tissue sections. Thus, neuromyelitis optica can be serologically diagnosed with relatively simple means and in particular also at laboratories, which have no recombinant cells or respective test systems, respectively, available. Furthermore, using complement incubation contrary to the conventional method, no previous pre-adsorption of the serums is required. Pre-adsorption serves the elimination of non-organ-specific antibodies, however, is associated with a reduction in sensitivity. Non-organ-specific antibodies as such ones against antinuclear antigens (ANA) are frequently present in samples of NMO patients and cause interfering, non-specific immunofluorescence on the neuronal tissue preparations. With complement incubation, on the other hand, the immunofluorescence pattern is specific also without pre-adsorption.

In a special further development, the examination method according to the invention is used to achieve higher sensitivity in the diagnosis of NMO diseases. For this reason, in a special embodiment of the invention, at least one patient sample is used, which has the characteristic, following wetting of a native tissue with the patient sample and subsequent incubation with fluorescein-marked anti-human IgG within the scope of an indirect immunofluorescence examination, not to show a fluorescence pattern typical for the binding of aquaporin-4 autoantibodies to the tissue. This patient sample is first applied on an aquaporin-4-containing native substrate, the autoantibodies present in the serum are reacted with components of the complement system, and the reaction of the complement system is detected by way of an indicator reaction. The complement reaction is preferably caused with C3c complement.

According to a special embodiment of the invention, in a three-stage examination method, frozen sections of tissues of the central nervous system are used. Particularly suited in that are tissue sections of cerebellum, hippocampus and/or optic nerve. Preferably, the frozen sections are applied on object slides, incubated with diluted patient serum (1:10 in phosphate-buffered saline solution, PBS) for 30 minutes, then for 10 minutes with undiluted pooled serum of healthy control persons (standardized complement source), and in a third step incubated separately from one another with fluorescein-marked antiserums against rabbit C1q, C3c and C4c (dilution 1:5 in PBS) for 30 minutes. After each step, the samples are washed in PBS three times. Finally, one drop of buffered glycerin is applied and a cover slip positioned. The reactions are assessed with a suitable fluorescence microscope common at the laboratory (excitation wavelength around 488 nanometers, emission wavelength over 520 nanometers, magnification 200- or 400-fold).

In order to prove the advantages of the method according to the invention, 83 serum samples of 14 patients with clinically clearly diagnosed neuromyelitis optica were examined with the conventional (two-stage) immunofluorescence technology and with the (three-stage) method according to the invention. In parallel, the serums of 20 patients with other neurological diseases as well as of 20 healthy blood donors were analyzed.

As antigen substrates, BIOCHIP mosaics made of frozen sections and cells were used. The mosaics included primate tissue (cerebellum, optic nerve, lower leg nerve, small intestine, pancreas) and rat tissue (cerebellum and hippocampus). As comparative substrates, BIOCHIPS with HEK293 cells were used, which expressed various other neurological recombinant autoantigens, for example glutamate receptors or potassium channel-associated proteins. With the two-stage (conventional) technique, all serums of the patients with NMO showed more or less weak reactions with cerebellum, hippocampus and optic nerve, while the control serums showed a negative reaction. Only 10% of the control serums showed weak, NMO-specific reactivity.

When the analyses were performed with the three-stage method based on complement activation of the present invention, for complement C4c, 81 of 83 serum samples of all the patients, and for complement C3c, 80 of 83 serums of 13 of the 14 patients showed a NMO-typical reaction.

Horizontal sections of the optic nerve fluoresced in a unique net-shaped pattern, while the cerebellum and the gyrus dentatus of the hippo-campus offered distinctive homogeneous cytoplasmatic staining predominantly of the granular layer. The strongest reactions were observed for complement C3c. The fluorescence signals were much clearer upon application of the method according to the invention (three-stage, with complement staining) and the patterns substantially more distinctive than with the conventional method.

In the following table, the results are shown in detail:

| | ANTI-NMO IgG | | | | Net-shaped | |
|---|---|---|---|---|---|---|
| | reactivity [%] | | | | pattern [%] | |
| | | | Primate | | Primate | |
| | AQP4-RC | | cerebellum | | optic nerve | |
| | Anti- | Anti- | Anti- | Anti- | Anti- | Anti- |
| | IgG | C3c | IgG | C3c | IgG | C3c |
| NMOSD | 100 | 98 | 88 | 96 | 75 | 96 |
| (n = 83) | | | | | | |
| Control group | 0 | 0 | 0 | 0 | 10 | 0 |
| (n = 40) | | | | | | |

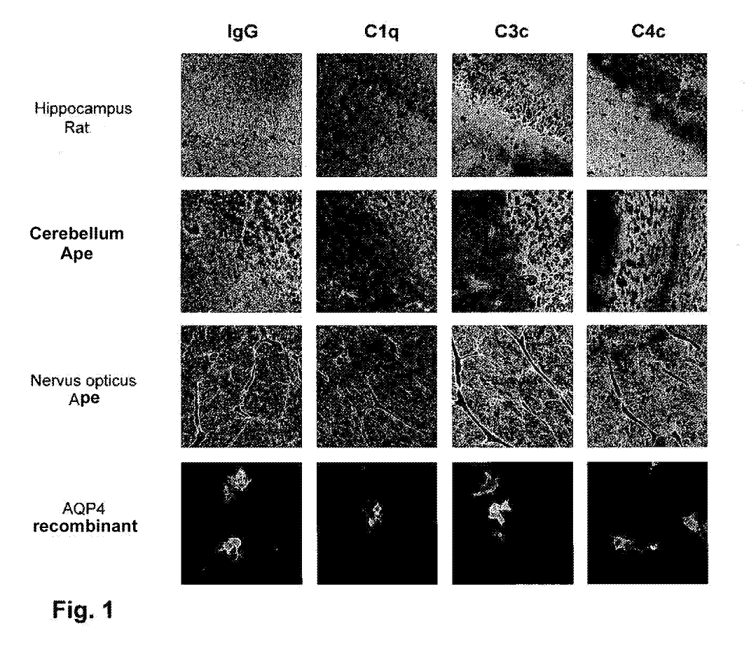

In respect of the examinations undertaken, FIGS. 1 to 3 show the fluorescence images taken of the various tissues following incubation.

FIG. 1 compares the fluorescence images of the hippocampus of a rat, primate cerebellum, primate optic nerve as well as a tissue section with transfected AQP-4 cells. Incubation of the tissue sections was respectively performed with anti-human immunoglobulin antibodies, C1q complement, C3c complement or C4c complement, respectively. The horizontal sections of the primate optic nerve fluoresced in a particularly distinctive net-shaped pattern, while the cerebellum and part of the brain structure of the hippocampus, namely the gyrus dentatus, offered distinctive homogeneous cytoplasmatic staining predominantly of the granular layer. The strongest reactions were observed for the complement C3c.

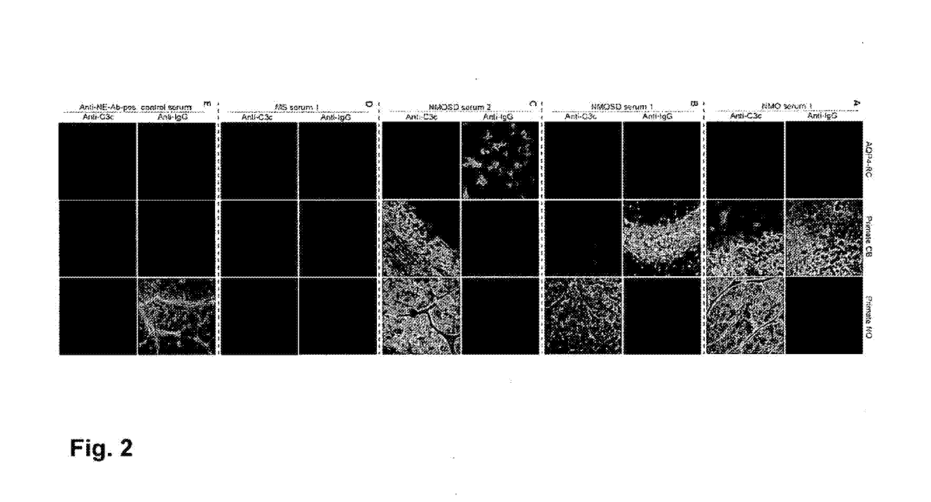

FIG. 2 respectively shows the fluorescence images of tissue sections of cells transfected with AQP4 (AQP4-RC-top row), primate cerebellum (primate CB-middle row) and primate optic nerve (primate NO-bottom row), which following incubation with patient serum as well as with anti-human immunoglobulin antibodies or C3c complement, respectively, were made visible using a fluorescence microscope. The patient serums used for incubation of the different tissue sections are a control serum (E), the serum of a MS patient (D), serums of patients with NMO syndrome (C, B) or a NMO patient (A), respectively. It is clearly noticeable that the fluorescence images of the tissue sections of the primate cerebellum and the primate optic nerve respectively incubated with serums of patients with NMO syndrome (C, B) or the NMO patient (A), respectively, as well as the C3c complement show a particularly intensive structure.

It is furthermore of significance that using complement incubation, contrary to the conventional method, no previous pre-adsorption of the serums is required. Pre-adsorption serves the elimination of non-organ-specific antibodies, which, however, is associated with a reduction in sensitivity. Non-organ-specific antibodies, like such ones against antinuclear antigens (ANA), are frequently present in samples of NMO patients and cause interfering, non-specific immunofluorescence on the neuronal tissue preparations. This can be noticed, for example, in FIG. 2 B, right-hand column, i.e. following incubation with the serum of a patient with NMO syndrome and with anti-human immunoglobulin antibodies. With complement incubation, on the other hand, the immunofluorescence pattern is also specific without pre-adsorption, as can be seen in FIG. 2 B, left-hand column, i.e. following incubation with the serum of a patient with NMO syndrome and with C3c complement.

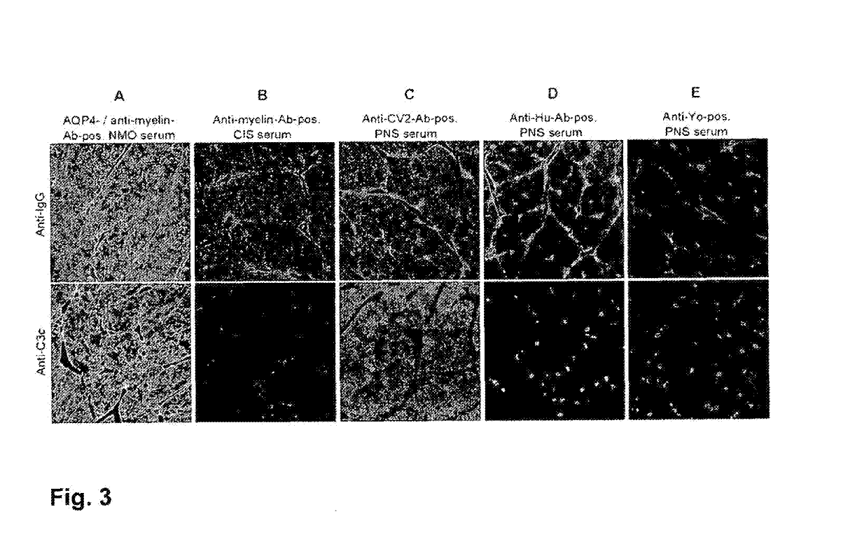

Concludingly, FIG. 3 shows fluorescence images of tissue sections, which were incubated with anti-human immunoglobulin antibodies (top row) or with C3c complement (bottom row), respectively, and subsequently made visible using a fluorescence microscope. For incubation of the tissue sections, different patient serums were used. Thus, serum of a NMO patient (A), serum of a patient with a clinically isolated syndrome (B) as well as serums of patients with paraneoplastic neurologic syndrome (C-E) were used. The incubated tissue sections respectively had different antigens. For the images in FIG. 3 A, a tissue to which AQP4 and antimyelin autoantibodies bind was used. For FIG. 3 B, a tissue to which anti-myelin autoantibodies bind was used, for FIG. 3 C, a tissue to which anti-CV2 autoantibodies bind, for FIG. 3 D, a tissue to which anti-Hu autoantibodies bind, and for FIG. 3 E, a tissue to which anti-Yo autoantibodies bind. Again, it is clearly noticeable that the tissue having AQP4 and anti-myelin autoantibodies shows the fluorescence image with the brightest and most intensive structure. Here, in particular incubation with C3c complement offers the possibility of a clear diagnosis in respect of the presence of AQP4 autoantibodies in the patient serum. It is thus shown that anti-aquaporin-4 antibodies can be clearly distinguished from other autoantibodies at least partially diagnostically relevant for neurology, like, e.g., anti-myelin, -Hu, -CV2, -Yo, using complement incubation.

According to an alternative embodiment of the invention, an examination is undertaken using an enzyme or luminescence immunoassay. Aquaporin-4 isolated from native hippocampus tissue is coupled to the surface of magnetic beads. These are incubated with diluted patient serum, then with undiluted pooled serum of ten healthy control persons (standardized complement source), and thereafter incubated with enzyme-marked antiserums against rabbit C1q, C3c or C4c. Subsequently, again, a staining reaction and photometric evaluation are undertaken. Alternatively, interior walls of reagent vessels may also be coated with antigen and used as the basis of common ELISA or luminescence tests, always with the intermediate complement step and complement-specific staining.

1-14. (canceled)

15. A method for the examination of a human patient sample for the presence of neuromyelitis optica-specific antibodies, comprising the steps of:
incubating an initial substrate with human sample material’
examining said incubated initial substrate using indirect immunofluorescence to determine whether neuromyelitis optica-specific antibodies have at least partially bound to said initial substrate, wherein, as said initial substrate, a native tissue section containing aquaporin-4 is used;
reacting said neuromyelitis optica-specific antibodies at least partially bound to said initial substrate with components of the complement system;
detecting a reaction of said complement system by way of an indicator reaction; and
differentiating a AQP4 autoantibody-containing patient sample from other autoantibodies diagnostically relevant for neurology.

16. The method according to claim 15, wherein said patient sample has the characteristic to show, following wetting of a native tissue with said patient sample and subsequent incubation with fluorescein-marked anti-human IgG within the scope of an indirect immunofluorescence examination, no fluorescence pattern typical for binding of aquaporin-4 autoantibodies to said tissue.

17. The method according to claim 15, wherein differentiation in respect of anti-myelin, anti-Hu and/or anti-CV-2 autoantibodies is performed.

18. The method according to claim 15, wherein differentiation in respect of anti-NMDA receptor, anti-AMPA receptor, anti-glutamate decarboxylase, anti-LGI-1, antiCASPR-2 autoantibodies is performed.

19. The method according to claim 15, wherein as said native substrate, a tissue section at least partially applied on an object slide is used.

20. The method according to claim 15, wherein as said native substrate, at least in part, tissue of the central nervous system is used.

21. The method according to claim 15, wherein said native substrate is at least partially taken from hippocampus, cerebellum and/or optic nerve.

22. The method according to claim 14, wherein said bound neuromyelitis optica-specific antibodies are indirectly or directly incubated with enzyme-marked antiserums against C1q, C3c or C4c.

23. The method according to claim 22, wherein enzyme-marked rabbit antiserums are used.

24. The method according to claim 15, wherein once said initial substrate is incubated with human sample material, a further incubation with undiluted serum of at least one healthy control person is performed.

25. A diagnostic kit for the examination of a human patient sample for the presence of neuromyelitis optica-specific antibodies and differentiation of AQP-4 autoantibodies present in a patient sample from other autoantibodies diagnostically relevant for neurology, wherein said kit has at least one aquaporin-4-containing initial substrate, wherein said aquaporin-4-containing initial substrate is a native tissue section containing aquaporin-4, which has been applied on an object slide.

26. The diagnostic kit according to claim 25, wherein said native tissue section is a tissue section taken from hippocampus, cerebellum and/or optic nerve.

27. The diagnostic kit for performing said method according claim 25, further having an examination slide, on which at least one native tissue section containing aquaporin-4 and at least one further substrate are arranged, wherein said initial substrate and said further substrate can be incubated with a human patient sample.
